(19) United States
(12) Patent Application Publication
(10) Pub. No.: US 2022/0396290 A1
(43) Pub. Date: Dec. 15, 2022

(54) Apparatus for Controlling Vehicle, System Including Same and Method Thereof

(71) Applicants: Hyundai Motor Company, Seoul (KR); Kia Corporation, Seoul (KR)

(72) Inventor: Tae Dong Oh, Seoul (KR)

(21) Appl. No.: 17/584,675

(22) Filed: Jan. 26, 2022

(30) Foreign Application Priority Data
Jun. 15, 2021 (KR) 10-2021-0077619

(51) Int. Cl. B60W 60/00; B60W 30/095

(52) U.S. Cl. CPC B60W 60/0027; B60W 30/0956; B60W 60/0011; B60W 60/0015; B60W 2554/80; B60W 2720/103; B60W 2554/4049

(57) ABSTRACT

An apparatus for controlling a vehicle includes an object selection device configured to select an object intersecting the vehicle at an intersection existing on a driving path of the vehicle, a risk determination device configured to determine a risk during driving of the vehicle based on a predicted path of the object, and a driving control device configured to determine a driving method of the vehicle based on a risk determination result.

### CROSS-REFERENCE TO RELATED APPLICATIONS

This application claims the benefit of Korean Patent Application No. 10-2021-0077619, filed on Jun. 15, 2021, which application is hereby incorporated herein by reference.

### TECHNICAL FIELD

The present disclosure relates to an apparatus for controlling a vehicle, a system including the same and a method thereof.

### BACKGROUND

In general, in autonomous driving without driver intervention, a vehicle is driven according to the speed limit set for each section. During autonomous driving, various driving profiles are generated to determine a driving path and a speed, and an autonomous driving operation is performed in such a manner that one profile is selected from the various driving profiles.

In particular, in a conventional autonomous driving scheme, because the connection relationship with intersections is not considered, a false warning caused by unnecessary objects is often generated. To the contrary, when only driving based on such a connection relationship is considered, a warning is not generated for objects travelling while ignoring the connection relationship.

In addition, in order to generate a predicted path of an object in an autonomous vehicle, a guideline is required as a reference. In general, lines are drawn on a road, and most vehicles drive along the lines, so that corresponding guidelines may be a lane. Meanwhile, at an intersection where some guide lines are drawn, it is recommended that vehicles drive along the guide lines, but the curvature of the guide lines is very high so that there are many vehicles that do not actually follow the guide lines, so the predicted path may be inaccurate.

As described above, there is a need to provide a method to effectively respond to all vehicles driving while maintaining the connection relationship with respect to the intersection and vehicles driving while ignoring the connection relationship.

### SUMMARY

Embodiments of the present disclosure can solve problems occurring in the prior art while advantages achieved by the prior art are maintained intact.

An embodiment of the present disclosure provides an apparatus for controlling a vehicle, which can effectively respond to an object travelling while ignoring a connection relationship with an object existing in the connection relationship with an intersection by selecting an end point based on the driving trajectory and dynamics information of the object and determining a predicted path of the object most suitable to exit the end point among several paths reflecting the dynamics information of the object, a system including the same, and a method thereof.

The technical problems that can be solved by embodiments of the present disclosure are not limited to the aforementioned problems, and any other technical problems not mentioned herein will be clearly understood from the following description by those skilled in the art to which the present disclosure pertains.

According to an embodiment of the present disclosure, an apparatus for controlling a vehicle includes an object selection device that selects an object intersecting the vehicle at an intersection existing on a driving path of the vehicle, a risk determination device that determines a risk during driving of the vehicle based on a predicted path of the object, and a driving control device that determines a driving method of the vehicle based on a risk determination result.

According to an embodiment, the object selection device may extract at least one candidate path that intersects the driving path of the vehicle, and select an object that simultaneously intersects the vehicle from among at least one object traveling along the candidate path.

According to an embodiment, the object selection device may calculate an intersection of the vehicle and the object, and select the object based on an occupancy time at the intersection of the vehicle and the object.

According to an embodiment, the risk determination device may calculate an end point at which the object exits the intersection based on the driving path of the object and dynamics information.

According to an embodiment, the risk determination device may calculate the end point through a first learning model based on the driving path of the object and the dynamics information.

According to an embodiment, the risk determination device may determine, as the predicted path of the object, a path having a greatest probability among paths on which the object is drivable to the end point and which are derivable based on the dynamics information of the object.

According to an embodiment, the risk determination device may generate a reference path having a gentlest curve form from a current location of the object to the end point, and determine, as the predicted path of the object, a candidate path having a smallest error from the reference path among at least one candidate path derivable based on the dynamics information of the object.

According to an embodiment, the risk determination device may determine, as the predicted path of the object, a path calculated through a second learning model based on at least one path derived based on the driving path of the object, dynamics information and the dynamics information of the object.

According to an embodiment, the risk determination device may determine the risk considering a time for the vehicle to reach an intersection of the vehicle and the object, a time for the vehicle to pass through the intersection of the vehicle and the object, a time for the object to reach the intersection of the vehicle and the object, and a time for the object to pass through the intersection of the vehicle and the object.

According to an embodiment, the driving control device may determine the driving method in which a minimum distance between the vehicle and the object is equal to or greater than a reference distance.

According to an embodiment, the driving control device may calculate a control parameter of the vehicle according to the driving method.

According to an embodiment, the control parameter may include the driving path and a speed profile of the vehicle.

According to an embodiment, the driving control device may determine the driving method by scheduling the driving path of the vehicle and the predicted path of the object by time.

According to an embodiment, the object selection device may select the object from a nearest intersection in the driving path of the vehicle among at least one intersection existing on the driving path of the vehicle.

According to an embodiment of the present disclosure, a vehicle system includes a sensor that detects an object around a vehicle, an information obtaining device that obtains location information and map information of the vehicle, and a vehicle control apparatus that selects an object intersecting the vehicle at an intersection existing on a driving path of the vehicle, determines a driving method of the vehicle based on a risk of the vehicle determined based on a predicted path of the object, and controls the vehicle based on a control parameter according to the driving method of the vehicle.

According to an embodiment, the sensor may detect information about a driving state of the vehicle.

According to an embodiment, the information obtaining device may obtain the location information of the vehicle and the map information from an external server.

According to an embodiment of the present disclosure, a method of controlling a vehicle includes selecting an object intersecting the vehicle at an intersection existing on a driving path of the vehicle, determining a risk during driving of the vehicle based on a predicted path of the object, and determining a driving method of the vehicle based on a risk determination result.

According to an embodiment, the method may further include calculating an end point at which the object exits the intersection based on a driving path of the object and dynamics information.

According to an embodiment, the method may further include determining, as the predicted path of the object, a path having a greatest probability among paths on which the object is drivable to the end point and which are derivable based on the dynamics information of the object.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a block diagram illustrating the configuration of a vehicle system including an apparatus for controlling a vehicle according to an embodiment of the present disclosure;

FIG. 2 is a block diagram illustrating the configuration of a vehicle control apparatus according to an embodiment of the present disclosure;

FIGS. 3A and 3B are diagrams illustrating various predicted paths of objects traveling through an intersection;

FIGS. 4A and 4B are diagrams illustrating a method of determining predicted paths of objects in an apparatus for controlling a vehicle according to an embodiment of the present disclosure;

FIGS. 5A and 5B are diagrams illustrating a method of calculating an end point of an object for an intersection by a vehicle control apparatus according to an embodiment of the present disclosure;

FIGS. 6A and 6B are diagrams illustrating a method of determining a predicted path of an object by a vehicle control apparatus according to an embodiment of the present disclosure;

FIGS. 7A-7C are diagrams illustrating a method of determining a driving method of a vehicle through scheduling by a vehicle control apparatus according to an embodiment of the present disclosure;

FIGS. 8A-8C are diagrams exemplarily illustrating driving methods of a vehicle generated by a vehicle control apparatus according to an embodiment of the present disclosure;

FIGS. 9A and 9B are views exemplarily illustrating a method of determining a driving method by a vehicle control apparatus according to an embodiment of the present disclosure;

FIG. 10 is a flowchart illustrating a vehicle control method according to another embodiment of the present disclosure; and

FIG. 11 is a block diagram illustrating a computing system according to each embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiments of the present disclosure, a detailed description of the related known configuration or function will be omitted when it is determined that it interferes with the understanding of the embodiments of the present disclosure.

In describing the components of the embodiments according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

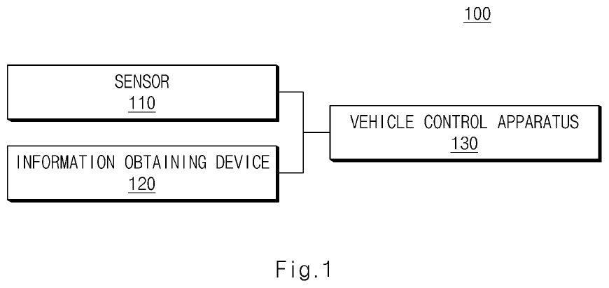

Hereinafter, embodiments of the present disclosure will be described in detail with reference to FIGS. 1 to 11.

FIG. 1 is a block diagram illustrating the configuration of a vehicle system including an apparatus for controlling a vehicle according to an embodiment of the present disclosure.

Referring to FIG. 1, a vehicle system 100 according to an embodiment of the present disclosure may be implemented inside a vehicle. In this case, the vehicle system 100 may be formed integrally with control units inside the vehicle, or may be implemented as a separate device and connected to the control units of the vehicle through separate connectors.

In addition, referring to FIG. 1, the vehicle system 100 according to an embodiment of the present disclosure may include a sensor no, an information obtaining device 120, and a vehicle control apparatus 130.

The sensor no may detect an object around the vehicle. That is, the sensor no may detect a distance and a relative speed of an object in front/rear of the vehicle, such as a vehicle in front/rear, a sign, an obstacle, and the like. For example, the sensor no may include a camera, a radar, and a Lidar.

In addition, the sensor no may include state information of various actuators of the vehicle. For example, the state information of the actuator of the vehicle may include the direction, speed, acceleration, angular velocity, and the like of the vehicle.

The information obtaining device 120 may acquire vehicle location information and map information. For example, the information obtaining device 120 may obtain current location information of the vehicle through GPS, and obtain precise map information such as a curvature of a road on which the vehicle is traveling, a current lane location of the vehicle, and the like. In this case, the information obtaining device 120 may store map information in separate storage (not shown), or may receive vehicle location information or map information from an external server through a communication device (not shown).

The vehicle control apparatus 130 may select an object that intersects the vehicle at an intersection existing on the driving path of the vehicle, and determine the driving method of the vehicle based on the risk of the vehicle determined based on the predicted path of the object. In addition, the vehicle control apparatus 130 may calculate a control parameter (e.g., a driving path, a speed profile, and the like) according to the determined driving method of the vehicle, and control the vehicle based on the control parameter.

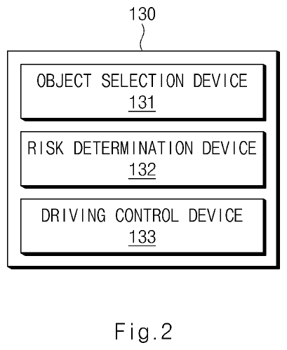

Hereinafter, a specific function of the vehicle control apparatus 130 will be described later in detail with reference to FIG. 2.

FIG. 2 is a block diagram illustrating the configuration of a vehicle control apparatus according to an embodiment of the present disclosure.

Referring to FIG. 2, the vehicle control apparatus 130 according to an embodiment of the present disclosure may include an object selection device 131, a risk determination device 132, and a driving control device 133.

The object selection device 131 may select an object that intersects with the vehicle at an intersection existing on the driving path of the vehicle. In this case, the object selection device 131 may extract at least one candidate path that intersects the driving path of the vehicle, and select an object that simultaneously intersects the vehicle among at least one object traveling along the candidate path.

In detail, the object selection device 131 may extract candidate paths that intersect the current driving path of the vehicle based on the precise map obtained by the information obtaining device 120 of FIG. 1, and may select an object that intersects or merges with the vehicle among the objects moving along the extracted candidate paths. In this case, the object selection device 131 may calculate the intersection of the vehicle and the object, and select the object based on the occupancy time at the intersection of the vehicle and the object. For example, the object selection device 131 may select the object based on whether the time at which the vehicle stays at the intersection of the vehicle and the object overlaps the time at which the object stays at the intersection of the vehicle and the object.

In addition, the object selection device 131 may select an object from the nearest intersection in the driving path of the vehicle among at least one intersection existing on the driving path of the vehicle. That is, the object selection device 131 may extract intersections in an order close to the lane on which the vehicle is traveling, based on the precise map information, and determine an object having a driving path intersecting each of the extracted intersections. In addition, the object selection device 131 may select objects having a high probability of danger through occupancy time of the vehicle and each object at the intersection of the vehicle and the object.

The risk determination device 132 may determine the risk based on the predicted path of the object when the vehicle is driven. In this case, the risk determination device 132 may determine the risk considering the time for the vehicle to reach the intersection of the vehicle and the object, the time for the vehicle to pass through the intersection of the vehicle and the object, the time for the object to reach the intersection of the vehicle and the object, the time for the object to pass through the intersection of the vehicle and the object, and the like.

In detail, the risk determination device 132 may calculate an end point at which the object exits from the intersection based on the driving path (e.g., past movement trajectory) and dynamics information (e.g., the speed, acceleration, travelling direction, and the like of the object) of the object. In this case, the risk determination device 132 may calculate an end point at which the object is determined to advance with the highest probability based on a driving path or dynamics information among a plurality of end points from which the object can advance from the intersection.

In addition, the risk determination device 132 may calculate the end point through the first learning model based on the driving path and dynamics information of the object. For example, the risk determination device 132 may calculate the probability for each end point where the object can advance from the intersection through a deep learning model, based on inputs such as the past trajectory information of the object, the driving direction, the current location, the longitudinal/lateral speed, the acceleration, and the like.

The risk determination device 132 may determine, as the predicted path of the object, a path along which the object is most likely to travel to the previously calculated end point among at least one path derivable based on the dynamics information of the object. For example, the risk determination device 132 may generate a reference path having the gentlest curve shape from the current location of the object to the calculated end point, and may determine, as the predicted path of the object, the candidate path having the smallest error from the reference path among at least one candidate path derivable based on the dynamics information of the object.

In addition, the risk determination device 132 may determine, as the predicted path of the object, the path calculated through the second learning model based on the driving path of the object, the dynamics information, and the at least one path derived based on the dynamics information of the object. For example, the risk determination device 132 may calculate a probability for each path along which an object can travel through an intersection through a deep learning model based on paths derived based on dynamics information, past trajectories, and dynamics information as inputs.

The driving control device 133 may determine the driving method of the vehicle based on the risk determination result. For example, the driving control device 133 may determine a driving method in which the minimum distance between the vehicle and the object is equal to or greater than a reference distance among a plurality of driving methods obtained according to the risk determined by the risk determination device 132. In addition, the driving control device 133 may determine the driving method by scheduling the driving path of the vehicle and the predicted path of the object for each time. In this case, the driving control device 133 may determine the driving method for each frame obtained at a preset time interval.

In addition, the driving control device 133 may calculate a control parameter of the vehicle according to the driving method. For example, the control parameter of the vehicle may include a driving route, a speed profile, and the like of the vehicle. Therefore, the vehicle control apparatus 130 may control the vehicle to travel without intersecting the object according to the calculated control parameter.

As described above, the vehicle control apparatus 130 according to an embodiment of the present disclosure may select the end point based on the driving trajectories and dynamics information of the objects, and determine the predicted path of the object that is most suitable to advance to the end point, among several routes reflecting the dynamics information of the objects, so that it is possible to effectively respond to an object existing on a connection relationship with an intersection and an object traveling while ignoring the connection relationship.

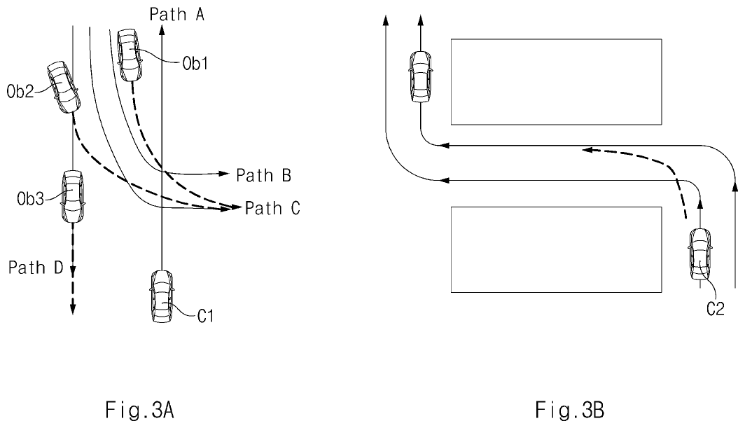

FIGS. 3A and 3B are diagrams illustrating various predicted paths of objects traveling through an intersection.

Referring to FIGS. 3A and 3B, reference numerals C1 and C2 represent vehicles, and reference numerals Ob1 to Ob3 represent objects driving around the vehicle C1. In addition, paths A to D of FIG. 3A represent paths along which the vehicle C1 and the objects Ob1 to Ob4 can travel.

In order to generate the predicted path of the object in the vehicle control apparatus 130, a guide line serving as a reference is required. In general, lines may be drawn on a road, and most vehicles may travel along the lines, so the guide line may be a lane link or a lane side. In this case, the lane link may be a virtual line extending from the center of a driving vehicle in general, and the lane side may be a line on a map of an area in which a vehicle is traveling.

Specifically, at intersections where some guide lines are drawn, it is a principle to drive along them, but because the curvature of such a guide line is very high, there may be many vehicles that do not actually follow the guide lines. That is, when generating the predicted path of an object, a guide line may be generated based on a lane link (e.g., a guide line) or a lane side (line), but at an actual intersection, there may be many vehicles that do not drive along such a lane link or lane side, so that the predicted path may be inaccurate.

As described above, referring to FIG. 3A, the vehicle C1 and the object Ob3 are traveling along the lane links Path A and Path D, but it may be understood that the objects Ob1 and Ob2 turning left at the intersection go out of the lane link and proceed to another path Path C. In addition, as shown in FIG. 3B, it may be understood that even in the case of the vehicle C2, the driving path is changed while passing between buildings.

As described above, in the case of an intersection where a vehicle makes a left/right turn or a U-turn, unlike a general straight lane, the driving paths of objects may appear different from the lines. Accordingly, the vehicle control apparatus 130 according to an embodiment of the present disclosure may calculate the predicted paths of objects at the intersection in various manners, and may detect, with high accuracy, the object that travels while ignoring the connection relationship with the object existing in the connection relationship with the intersection.

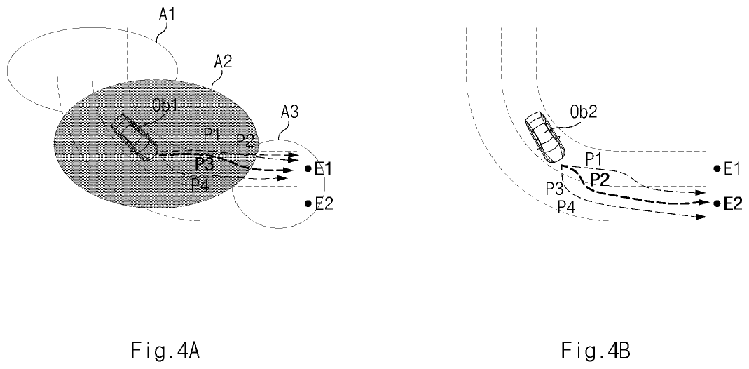

FIGS. 4A and 4B are diagrams illustrating a method of determining predicted paths of objects in an apparatus for controlling a vehicle according to an embodiment of the present disclosure.

Referring to FIGS. 4A and 4B, reference numerals A1 and A3 indicate an area in which the objects Ob1 and Ob2 enter an intersection (e.g., a left turn section) and an area from which the objects Ob1 and Ob2 exit, respectively. Reference numeral A2 indicates an intersection area in which an object turns left. In addition, reference numerals P1 to P4 indicate several paths along which the objects Ob1 and Ob2 reach an end point E1, and reference numerals E1 and E2 indicate the end points to which the objects Ob1 and Ob2 can exit from the intersection. Further, the object Ob1 shown in FIG. 4A represents a vehicle traveling in a connecting lane of an intersection (i.e., a vehicle traveling along an existing lane), and the object Ob2 shown in FIG. 4B represents a vehicle traveling in an unconnected lane of an intersection (i.e., a vehicle changing the lane at an intersection).

In the case of area A1 of FIG. 4A, a clear line generally exists before the object Ob1 enters the intersection, so that the object Ob1 is relatively accurately aligned with the corresponding line. In addition, in the case of area A3, it may be understood that even after the object Ob1 advances from the intersection, there is a clear lane, so that vehicles tend to align within the corresponding line.

However, as in area A2, there are no lines or only a guide line exists inside the intersection, and as described above, even if there is a guide line, many vehicles actually travel outside the guide line. Accordingly, when a degree at which the objects Ob1 and Ob2 do not follow the driving line is defined as a ‘degree of freedom’, the degree of freedom may tend to be greater inside the intersection than before entering and after exiting the intersection. That is, areas A1 and A3 of FIG. 4 are areas having a relatively low degree of freedom, and area A2 is an area having a relatively high degree of freedom.

As described above, the vehicle control apparatus 130 according to an exemplary embodiment of the present disclosure may determine information about a point (e.g., area A1) having a relatively low degree of freedom in order to process the objects Ob1 and Ob2 travelling on an unconnected lane within an intersection in a consistent manner, and may calculate the predicted path most suitable for the determined information based on a plurality of prediction paths in an area with a high degree of freedom. Accordingly, the vehicle control apparatus 130 according to an embodiment of the present disclosure may first determine to which point the objects Ob1 and Ob2 will first exit (i.e., an end point), and then may calculate the path most suitable for the objects Ob1 and Ob2 to exit to the corresponding end point.

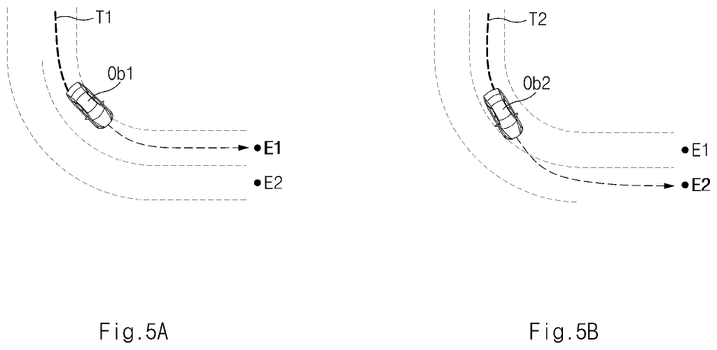

FIGS. 5A and 5B are diagrams illustrating a method of calculating an end point of an object for an intersection by a vehicle control apparatus according to an embodiment of the present disclosure.

Referring to FIGS. 5A and 5B, paths T1 and T2 represent past trajectories of objects Ob1 and Ob2, respectively. Reference numerals E1 and E2 represent the end points at which the objects Ob1 and Ob2 exit the intersection. In addition, the object Ob1 shown in FIG. 5A represents a vehicle traveling in a connecting lane of an intersection (that is, a vehicle traveling along an existing lane), and the object Ob2 shown in FIG. 5B represents a vehicle traveling in an unconnected lane of an intersection (i.e., a vehicle changing the lane at an intersection).

As shown in FIGS. 5A and 5B, in order to search for intersection end points E1 and E2 of the objects Ob1 and Ob2, the predicted paths suitable for the driving of the objects Ob1 and Ob2 may be calculated based on the past driving trajectories T1 and T2 of the corresponding objects Ob1 and Ob2 and the current dynamics information. In this case, in order to calculate an appropriate predicted path, a predicted path may be calculated by using a path generation algorithm based on longitudinal acceleration and velocity information, lateral acceleration and velocity information, heading direction, past trajectory information, and the like of the vehicle.

In this case, the predicted path may be used, as preliminary information, not for a process for calculating a sophisticated predicted path of the objects Ob1 and Ob2, but for determining in advance which one of the end points E1 and E2 the objects Ob1 and Ob2 are likely to approach. Even in the case of the object Ob2 traveling on the unconnected path, it is possible to finally determine to which end point E1 or E2 the object Ob2 is likely to approach by comparing the end points with the end points E1 and E2 of the predicted path calculated in the above-described manner.

Meanwhile, in addition to the above-described method, the vehicle control apparatus 130 may calculate the intersection end points of the objects Ob1 and Ob2 based on a deep learning model (e.g., the first learning model of FIG. 2). In this case, the past trajectory information of the object and the lateral error (distance) according to the longitudinal distance between the lanes may be configured in an array and input to an input layer of the first learning model. In addition, the dynamics information such as the moving direction, longitudinal/lateral velocity, acceleration, current location, and the like of an object may be input to the input layer of the first learning model. In this case, the intermediate layers of the first learning model may be configured using a deep neural network model (e.g., CNN, LSTM, and the like) through deep learning.

In addition, the vehicle control apparatus 130 according to an embodiment of the present disclosure may configure dense layers as many as the number of candidates of the end points to select the final end points of the objects Ob1 and Ob2, and may finally take the output value with the highest probability by performing post-processing such as softmax of the dense layers.

Meanwhile, the input form for the first learning model may be configured in an image classification method in which pixel values are directly input by expressing the past trajectory form on the map as an image as well as the departure distance from the trajectories on the path of the objects Ob1 and Ob2 and the dynamics information. In addition, the data set of the first learning model may target the final end points (E1, E2) of the intersection driving of the objects Ob1 and Ob2, and the past trajectory and dynamics information (if the time interval between frames is very short, the past trajectory coordinates may contain a lot of dynamics information) may be configured as input.

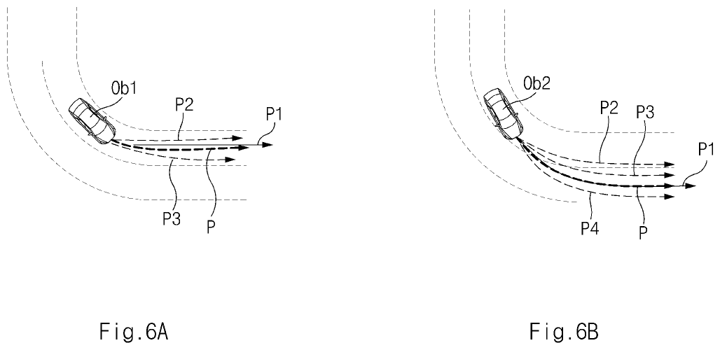

FIGS. 6A and 6B are diagrams illustrating a method of determining a predicted path of an object by a vehicle control apparatus according to an embodiment of the present disclosure.

Reference numerals P1 to P3 in FIG. 6A and P1 to P4 in FIG. 6B represent paths along which the objects Ob1 and Ob2 travel to the calculated end points, respectively. In this case, FIGS. 6A and 6B, the path P1, which is a path generated in the gentlest curve form from the current location of the objects Ob1 and Ob2 to the calculated end point, may be a guide path. In addition, the paths P2 and P3 of FIG. 6A and the paths P2 to P4 of FIG. 6B may be predicted paths calculated based on dynamics information of the objects Ob1 and Ob2.

That is, as described with reference to FIGS. 5A and 5B, when one end point is determined, the vehicle control apparatus 130 according to an embodiment of the present disclosure may generate the guide path P1 in a gentle curve form from the current location of the objects Ob1 and Ob2 to the corresponding end point. In addition, the remaining paths P2 to P4, which are a set of drivable multi-paths in which the current dynamics information of the objects Ob1 and Ob2 is reflected, may finally obtain the path with the least degree of deviation through a comparison method (e.g., L2 norm) with the previously calculated guide path P1 for each path.

As described above, the vehicle control apparatus 130 according to an embodiment of the present disclosure may obtain the path that is gently connected to an end point among various paths with a very high driving possibility of the objects Ob1 and Ob2. The final path calculated as described above is denoted as ‘P’ in FIGS. 6A and 6B, and in the case of FIGS. 6A and 6B, the final path P coincided with the guide path P1, but the path calculated based on the dynamics information and the guide path P1 may not match depending on the situation, for example, in a case in which a path deviating from the guide path is more likely to be driven than the guide path in terms of dynamics.

Meanwhile, the vehicle control apparatus 130 according to an embodiment of the present disclosure may calculate the final predicted path of the objects Ob1 and Ob2 based on a deep learning model (e.g., the second learning model of FIG. 2) in addition to the above-described method. In this case, the lateral error (distance) according to the longitudinal distance between the obtained predicted paths of the objects Ob1 and Ob2 and the driving lane link may be configured in an array and input to the input layer. In this case, various path generation algorithms may be used to generate the predicted path of the objects Ob1 and Ob2. In addition, the dynamics information, such as the moving direction, longitudinal/lateral velocity, acceleration, current location, and the like of the object Ob1 and Ob2 may be input to the input layer of the second learning model. In this case, the intermediate layers of the second learning model may be configured using a deep neural network model (e.g., CNN, LSTM, and the like) through deep learning.

In addition, the vehicle control apparatus 130 according to an embodiment of the present disclosure may configure dense layers as many as the number of candidates of the end points to select the final end points of the objects Ob1 and Ob2, and may finally take the output value with the highest probability by performing post-processing such as softmax of the dense layers.

Meanwhile, the input form for the second learning model may be configured in an image classification method in which pixel values are directly input by expressing the past trajectory form on the map as an image as well as the departure distance from the trajectories on the path of the objects Ob1 and Ob2 and the dynamics information. In addition, the data set of the second learning model may target the actual driving path of the objects Ob1 and Ob2, and the past trajectories of the objects Ob1 and Ob2, dynamics information, and a plurality of generated predicted paths may be configured as inputs.

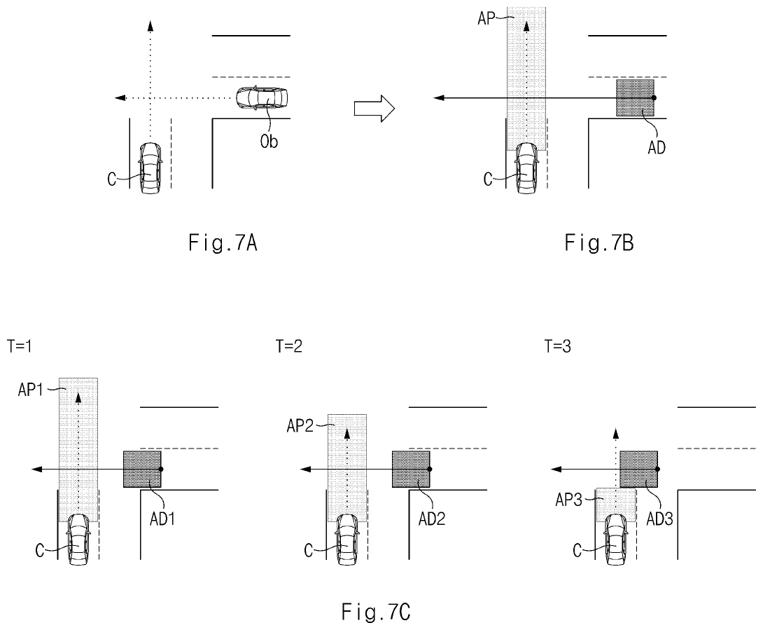

FIGS. 7A-7C are diagrams illustrating a method of determining a driving method of a vehicle through scheduling by a vehicle control apparatus according to an embodiment of the present disclosure.

Referring to FIGS. 7A-7C, ‘C’ denotes a vehicle and Ob denotes an object likely to intersect with the vehicle. Further, AP1 to AP3 indicate drivable areas of the vehicle ‘C’, and AD1 to AD3 indicate danger areas due to the object Ob.

FIGS. 7A-7C exemplarily illustrate that, in response to blocking the path of the vehicle ‘C’ by the intersection driving of the object Ob through the scheduling for the driving method, the vehicle control apparatus 130 according to an embodiment of the present disclosure causes the vehicle ‘C’ to travel more naturally through changing of the driving lane.

In FIGS. 7A-7C, when the object Ob intends to travel through an intersection and the dynamic characteristic of the object Ob is currently driving at the intersection to the target lane, a driving predicted path from the current driving lane to the target lane is formed, and an area excluding the expected locations of the vehicle ‘C’ and the object Ob and a vehicle occupancy area AD in each time frame may be the drivable area AP in the corresponding frame of the vehicle ‘C’.

For example, as shown in FIG. 7A-7C, when the driving intention of the object Ob is to drive at a constant speed while maintaining the current lane, and the current dynamic characteristic is constant speed driving in the driving lane, the deceleration predicted path (e.g., AP1 to AP3 in FIG. 7C) of the vehicle ‘C’ that does not collide (intersect) with a surrounding object Ob in the current driving lane may be formed and the area excluding the expected location and the vehicle occupancy areas AD1 to AD3 in each time frame may be drivable areas AP1 to AP3 in the corresponding frame of the vehicle ‘C’.

In addition, in the frame of each time (e.g., T=1 second, 2 seconds, 3 seconds) shown in FIGS. 7A-7C, the vehicle ‘C’ may have a degree of freedom in a range of physically possible distances from the previous location within the drivable areas AP1 to AP3, and it is possible to determine the validity of the path through the predicted path of the object Ob and the possibility of collision in each time frame.

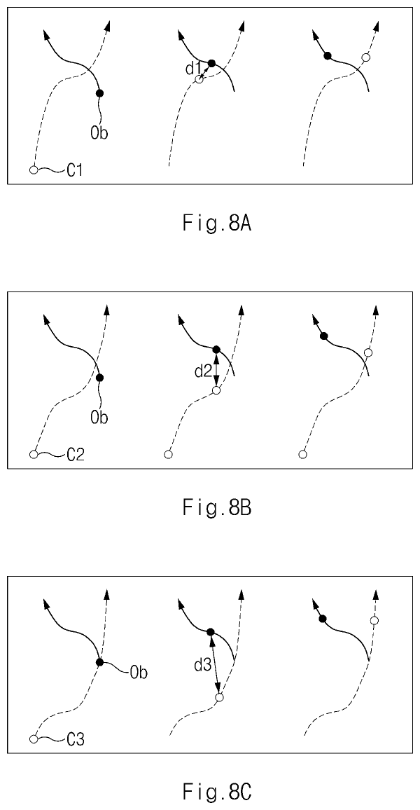

FIGS. 8A-8C are diagrams exemplarily illustrating driving methods of a vehicle generated by a vehicle control apparatus according to an embodiment of the present disclosure.

Referring to FIGS. 8A-8C, C1 to C3 denote a vehicle including the vehicle control apparatus 130 according to an embodiment of the present disclosure, and Ob denotes an object intersecting the vehicles C1 to C3. In addition, d1 to d3 represent the minimum distances between the vehicles C1 to C3 and the object Ob. As described above, FIGS. 8A-8C schematically illustrate a crossing travel path of the vehicles C1 to C3 and the object Ob.

As shown in FIGS. 8A-8C, in response to the blocking of the path of the vehicles C1 to C3 by the object Ob, the vehicles C1 to C3 are induced to travel more naturally through changing of the driving lane. As described above, when the predicted path of the object Ob according to time is determined through the vehicle control apparatus 130 according to an embodiment of the present disclosure, the vehicles C1 to C3 must plan the driving paths, and this series of processes may be implemented through scheduling for the driving method.

In addition, the vehicles C1 to C3 may generate various possible routes based on dynamics information and the like, and may include various longitudinal/lateral velocity profiles of the vehicles C1 to C3 in each path. Then, with respect to generated N driving methods, it may be determined whether a collision (intersection) is possible for each time frame between the predicted paths of the vehicle C1 to C3 and the predicted path of the object Ob, and the most optimal method may be selected based on a reference of a next frame.

For example, referring to FIG. 8A, while the minimum distance di between the vehicle C1 and the object Ob is relatively close, because the minimum distances d2 and d3 between the vehicles C2 and C3 and the object Ob in FIGS. 8B and 8C are secured by a specified distance or more, the vehicle control apparatus 130 according to an embodiment of the present disclosure may select the driving method corresponding to FIG. 8B or 8C.

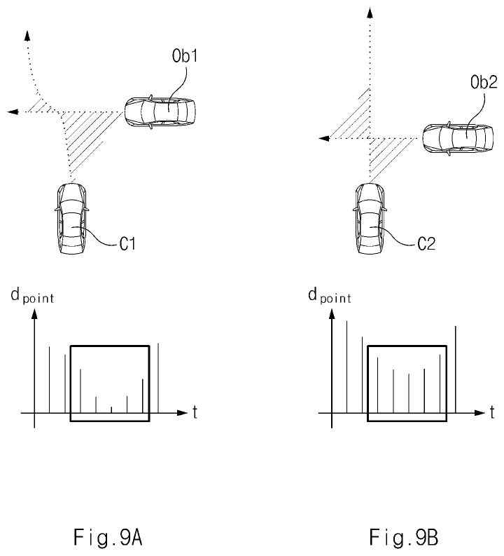

FIGS. 9A and 9B are views exemplarily illustrating a method of determining a driving method by a vehicle control apparatus according to an embodiment of the present disclosure.

Referring to FIGS. 9A and 9B, C1 and C2 indicate vehicles including the vehicle control apparatus 130 according to an embodiment of the present disclosure, and Ob1 and Ob2 represent objects that are likely to intersect with vehicles C1 and C2. In addition, in the lower graphs of FIGS. 9A and 9B, the x-axis represents time, and the y-axis represents the distance between the vehicles C1 and C2 and the objects Ob1 and Ob2 according to time.

As described above, the vehicle control apparatus 130 according to an embodiment of the present disclosure may determine a method that most satisfies a preset reference among the generated N driving methods. In the example of FIGS. 9A and 9B, the reference is focused on the safety of the vehicle during driving, and the limit reference is described as a condition in which the distance between the vehicle and the object is greater than or equal to a threshold and the sum of the distances between them is the maximum, but it is possible to change or supplement the reference in various manners to secure stability, ride comfort, naturalness, and the like.

For example, in FIGS. 9A and 9B, because the predicted paths of the vehicle and the object calculated by the vehicle control apparatus 130 according to an embodiment of the present disclosure includes location information of the object by time, the expected relative distance dₚₒᵢₙₜₛ(t) between the objects by time may be calculated. In addition, when the distance dₚₒᵢₙₜₛ(t) between the vehicle and the object at a specific time ‘t’ becomes smaller than a preset reference value, the corresponding path may cause a great risk and thus may be excluded from the candidates. In this case, the reference value may be set as the minimum time during which the vehicles C1 and C2 can respond to the collision with the objects Ob1 and Ob2.

That is, as shown in FIG. 9A, when the distance between the vehicle C1 and the object Ob1 by time is less than the reference value, the vehicle control apparatus 130 according to an embodiment of the present disclosure may not select the corresponding driving method. To the contrary, as shown in FIG. 9B, when the distance between the vehicle C2 and the object Ob2 by time is equal to or greater than a specified reference value, the vehicle control apparatus 130 according to an embodiment of the present disclosure may select the corresponding driving method.

Meanwhile, in FIGS. 9A and 9B, although the distances between the vehicles C1 and C2 and the objects Ob1 and Ob2 by time are used, the vehicle control apparatus 130 according to an embodiment of the present disclosure may determine the probability of collision between the vehicles C1 and C2 and the objects Ob1 and Ob2 by using significant statistical methods such as a sum of relative distances by time, an average value, a minimum value, a median value, and the like.

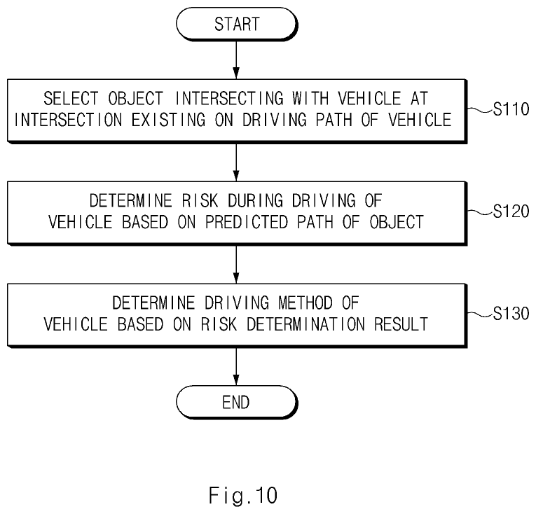

Hereinafter, a vehicle control method according to another embodiment of the present disclosure will be described in detail with reference to FIG. 10. FIG. 10 is a flowchart illustrating a vehicle control method according to another embodiment of the present disclosure.

Hereinafter, it is assumed that the vehicle control apparatus 130 of FIGS. 1 and 2 performs the process of FIG. 10. In addition, in the description of FIG. 10, an operation described as being performed by a device may be understood as being controlled by a processor (not shown) of the vehicle control apparatus 130.

FIG. 10 is a flowchart illustrating a method of controlling a vehicle according to an embodiment of the present disclosure.

Referring to FIG. 10, a method of controlling a vehicle according to an embodiment of the present disclosure may first select an object intersecting the vehicle at the intersection existing on the driving path of a vehicle in Silo. In this case, at least one candidate path that intersects the driving path of the vehicle may be extracted, and an object that simultaneously intersects the vehicle may be selected from at least one object traveling along the candidate path.

In detail, in S110, candidate paths that intersect with the path along which the vehicle is currently traveling may be extracted based on a precise map and an object that intersects or merges with the vehicle may be selected from objects traveling along the extracted candidate path. In this case, the intersection of the vehicle and the object may be calculated, and an object may be selected based on the occupancy time at the intersection of the vehicle and the object.

In addition, in S110, an object may be selected from the nearest intersection in the driving path of the vehicle among at least one intersection existing on the driving path of the vehicle. That is, based on the precise map information, intersections may be extracted in an order close to the lane on which the vehicle is traveling, and it is possible to determine an object having an intersecting driving path for each of the extracted intersections. In addition, based on the occupancy time of the vehicle and the object at each intersection of the vehicle and the object, high-risk objects may be selected.

Next, in S120, based on the predicted path of the object, it is possible to determine the risk during driving of the vehicle. In this case, the risk may be determined in consideration of the time for the vehicle to reach the intersection of the vehicle and the object, the time for the vehicle to pass through the intersection of the vehicle and the object, the time for the object to reach the intersection of the vehicle and the object, the time for the object to pass through the intersection of the vehicle and the object, and the like.

In detail, in S120, it is possible to calculate the end point at which the object exits the intersection based on the driving path of the object (e.g., past movement trajectory) and dynamics information (e.g., the speed, acceleration, direction of travel, and the like of an object). In this case, it is possible to calculate the end point at which the object advances with the highest probability based on the driving path, dynamics information, and the like among a plurality of end points from which the object can advance from the intersection.

In addition, in S120, the end point may be calculated through the first learning model based on the driving path and dynamics information of the object. For example, by inputting the past trajectory information of the object, the travelling direction, the current location, the longitudinal/lateral speed, the acceleration, and the like, the probability for each end point at which the object can advance from the intersection may be calculated through the deep learning model.

In S120, the path that is most likely to travel to the previously calculated end point among at least one path derivable based on the dynamics information of the object may be determined as the predicted path of the object. For example, a reference path having the smoothest curve form from the current location of the object to the calculated end point may be generated, and the candidate path having the error from the reference path, which is the smallest among at least one candidate path derived based on the dynamics information of the object, may be determined as the predicted path of the object.

In addition, in S120, the predicted path of the object may be determined from the path calculated through the second learning model based on the driving path of the object, the dynamics information, and at least one path derived based on the dynamics information of the object. For example, by inputting the paths derived based on dynamics information, past trajectories, dynamics information, and the like, the probability of each path where the object can travel through the intersection may be calculated through the deep learning model.

In addition, in S130, it is possible to determine the driving method of the vehicle based on the risk determination result. For example, in S130, the driving method may be determined, in which the minimum distance between the vehicle and the object is equal to or greater than the reference distance among the plurality of driving methods obtained according to the risk determined in S120. In addition, the driving method may be determined by scheduling the driving path of the vehicle and the predicted path of the object by time. In this case, the driving method may be determined for each frame acquired at a preset time interval.

In addition, in S130, the control parameter of the vehicle according to the driving method may be calculated. For example, the control parameter of the vehicle may include the driving path, the speed profile and the like of the vehicle. Accordingly, it is possible to control the vehicle to drive without intersecting the object according to the calculated control parameter.

As described, the method of controlling a vehicle according to an embodiment of the present disclosure may select the end point based on the driving trajectories and dynamics information of objects, and determine the predicted path of the object suitable to advance to the end point among several paths reflecting the dynamics information of the object, so that it is possible to effectively respond to the object that is travelling while ignoring the connection relationship with an object existing on the intersection.

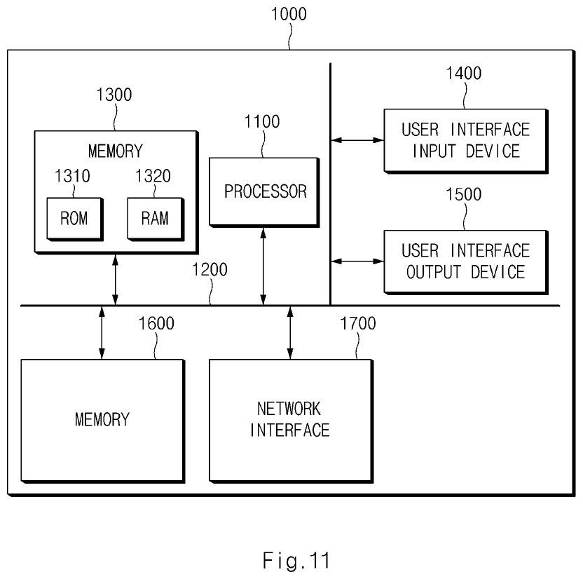

FIG. 11 is a block diagram illustrating a computing system according to each embodiment of the present disclosure.

Referring to FIG. 11, a computing system 1000 may include at least one processor 1100, a memory 1300, a user interface input device 1400, a user interface output device 1500, a memory (i.e., a storage) 1600, and a network interface 1700 connected through a bus 1200.

The processor 1100 may be a central processing device (CPU) or a semiconductor device that processes instructions stored in the memory 1300 and/or the memory 1600. The memory 1300 and the memory 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the memory 1600), such as a RAM, a flash memory, a ROM, an EPROM, an EEPROM, a register, a hard disk, solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

According to the embodiments of the present disclosure, the vehicle control apparatus, the system including the same, and the method thereof may select the end point based on the driving trajectories and dynamics information of objects, and determine the predicted path of the object suitable to advance to the end point among several paths reflecting the dynamics information of the object, so that it is possible to effectively respond to the object that is travelling while ignoring the connection relationship with an object existing on the intersection.

In addition, various effects that are directly or indirectly understood through the present disclosure may be provided.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for controlling a vehicle, the apparatus comprising:
an object selection device configured to select an object intersecting the vehicle at an intersection existing on a driving path of the vehicle;
a risk determination device configured to determine a risk during driving of the vehicle based on a predicted path of the object; and
a driving control device configured to determine a driving method of the vehicle based on a risk determination result.

2. The apparatus of claim 1, wherein the object selection device is configured to extract at least one candidate path that intersects the driving path of the vehicle, and select an object that simultaneously intersects the vehicle from among one or more objects traveling along the candidate path.

3. The apparatus of claim 1, wherein the object selection device is configured to calculate an intersection of the vehicle and the object and to select the object based on an occupancy time at the intersection of the vehicle and the object.

4. The apparatus of claim 1, wherein the risk determination device is configured to calculate an end point at which the object exits the intersection based on the driving path of the object and dynamics information.

5. The apparatus of claim 4, wherein the risk determination device is configured to calculate the end point through a first learning model based on the driving path of the object and the dynamics information.

6. The apparatus of claim 4, wherein the risk determination device is configured to determine, as the predicted path of the object, a path having a greatest probability among paths on which the object is drivable to the end point and which are derivable based on the dynamics information of the object.

7. The apparatus of claim 6, wherein the risk determination device is configured to generate a reference path having a gentlest curve form from a current location of the object to the end point, and to determine, as the predicted path of the object, a candidate path having a smallest error from the reference path among at least one candidate path derivable based on the dynamics information of the object.

8. The apparatus of claim 6, wherein the risk determination device is configured to determine, as the predicted path of the object, a path calculated through a second learning model based on at least one path derived based on the driving path of the object, dynamics information and the dynamics information of the object.

9. The apparatus of claim 1, wherein the risk determination device is configured to determine the risk considering a time for the vehicle to reach an intersection of the vehicle and the object, a time for the vehicle to pass through the intersection of the vehicle and the object, a time for the object to reach the intersection of the vehicle and the object, and a time for the object to pass through the intersection of the vehicle and the object.

10. The apparatus of claim 1, wherein the driving control device is configured to determine the driving method in which a minimum distance between the vehicle and the object is equal to or greater than a reference distance.

11. The apparatus of claim 1, wherein the driving control device is configured to calculate a control parameter of the vehicle according to the driving method.

12. The apparatus of claim 11, wherein the control parameter includes the driving path and a speed profile of the vehicle.

13. The apparatus of claim 1, wherein the driving control device is configured to determine the driving method by scheduling the driving path of the vehicle and the predicted path of the object by time.

14. The apparatus of claim 1, wherein the object selection device is configured to select the object from a nearest intersection in the driving path of the vehicle among at least one intersection existing on the driving path of the vehicle.

15. A vehicle system comprising:
a sensor configured to detect an object around a vehicle;
an information obtaining device configured to obtain location information and map information of the vehicle; and
a vehicle control apparatus configured to select an object intersecting the vehicle at an intersection existing on a driving path of the vehicle, determine a driving method of the vehicle based on a risk of the vehicle determined based on a predicted path of the object, and control the vehicle based on a control parameter according to the driving method of the vehicle.

16. The vehicle system of claim 15, wherein the sensor is configured to detect information about a driving state of the vehicle.

17. The vehicle system of claim 15, wherein the information obtaining device is configured to obtain the location information of the vehicle and the map information from an external server.

18. A method of controlling a vehicle, the method comprising:
selecting an object intersecting the vehicle at an intersection existing on a driving path of the vehicle;
determining a risk during driving of the vehicle based on a predicted path of the object; and
determining a driving method of the vehicle based on a risk determination result.

19. The method of claim 18, further comprising calculating an end point at which the object exits the intersection based on a driving path of the object and dynamics information.

20. The method of claim 19, further comprising determining, as the predicted path of the object, a path having a greatest probability among paths on which the object is drivable to the end point and which are derivable based on the dynamics information of the object.
